(19) United States
(12) Patent Application Publication
(10) Pub. No.: US 2005/0183131 A1
(43) Pub. Date: Aug. 18, 2005

(54) System and method for providing integrated communications and broadcasting service

(76) Inventors: Kang Bok Lee, Daejeon-city (KR); Heyung Sub Lee, Daejeon-city (KR); Sang Yeoun Lee, Daejeon-city (KR); Hong Soon Nam, Daejeon-city (KR); Bong Tae Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/975,222

(22) Filed: Oct. 27, 2004

(30) Foreign Application Priority Data
Feb. 12, 2004 (KR) 2004-9246

(51) Int. Cl. H04N 7/173

(52) U.S. Cl. 725/111; 725/118; 725/119; 725/129

(57) ABSTRACT

A system for and a method of providing an integrated communications and broadcasting service are provided. This system includes a transmitter and a receiver. The transmitter converts a CATV broadcasting signal and a satellite broadcasting signal into a CATV broadcasting optical signal and a satellite broadcasting optical signal having predetermined wavelengths, wavelength-multiplexes the two broadcasting optical signals, and wavelength-multiplexes a wavelength-multiplexed broadcasting optical signal with an Internet data signal to transmit an integrated communications and broadcasting optical signal via a predetermined optical fiber. The receiver receives the integrated communications and broadcasting optical signal from the transmitter, demultiplexes the received signal according to a wavelength band, converts the CATV broadcasting optical signal, the satellite broadcasting optical signal, and the Internet data signal, into which the received signal is demultiplexed, into RF signals, and transports the RF signals to appropriate terminals.

### BACKGROUND OF THE INVENTION

This application claims the benefit of Korean Patent Application No. 2004-9246, filed on Feb. 12, 2004, in the Korean Intellectual Property Office, the disclosure of which is incorporated herein in its entirety by reference.

1. Field of the Invention

The present invention relates to a broadcasting and communications network, and more particularly, to a system for and a method of providing an integrated communications and broadcasting service through a single network.

2. Description of the Related Art

Present network infrastructures of communications and broadcasting are each divided into several types. A broadcasting network has been developed from a terrestrial network to a satellite broadcasting network via a CATV network. Depending on an application location of communications equipment, a performance of the communications equipment, and a type of communications, a communications network has been developed into various networks including wire and wireless communication networks.

At present, home subscribers receive an Internet service and a video on demand (VOD) broadcasting service from an Internet service provider (ISP) through their PCs. Also, home subscribers receive a multi-channel broadcasting using terminals, such as, TVs, either through a terrestrial network or through various media, such as, a CATV wire broadcasting network or a satellite broadcasting network.

However, a subscriber must include various systems suitable for various broadcasting services to receive the various broadcasting services. In other words, systems, such as, a cable network, a CATV settop box (STB), and the like, are necessary for CATV broadcasting. A separate satellite antenna and a satellite STB are necessary for CATV broadcasting. An Internet Protocol digital subscriber line access multiplexer (IP DSLAM) system, a modem, and separate equipment must be established to receive VOD services. Due to this reality where broadcasting services are not united, the costs for using various services are increased, which is consequently burdensome to home subscribers.

This current network structure does not meet customers' expectations that customers can receive an integrated communications and broadcasting service in a current situation where multi-media services are mainly performed. A combined network structure, where an integrated communications and broadcasting service can be implemented, is increasingly demanded and expected.

An attempt to provide communications services and broadcasting services using a single transmission line and a single receiver instead of using various transmission channels and various receivers has been made in many aspects. Examples of this attempt include a method of providing an Internet service through a CATV network and a method of connecting a digital subscriber line (xDSL) directly to a TV instead of a PC.

A method of receiving Internet and broadcasting services through a TV by combining broadcasting and communications together has been actively developed. Also, several techniques for providing through a single communications network various types of broadcasting services that require various media even though all of the services belong to broadcasting have been developed.

Examples of the developed techniques include a method of providing an integrated communications and broadcasting service using an existing CATV network, a method of providing broadcasting services by applying an optical signal overlay structure to an existing communications channel, a method of combining broadcasting services using an IP packet and a real time protocol (RTP) that provides real time services in the Internet network, and the like. In the method using the existing cable network (e.g., a hybrid fiber coaxial (HFC) network), a broadcasting network covers a data communications service, such as, an ultra-fast Internet. In the method of combining broadcasting services using the RTP, a data communications network, that is, the Internet network, covers a multi-channel broadcasting.

FIG. 1 illustrates a structure of a conventional HFC CATV network. This network is proposed in a conventional art to perform broadcasting and communications.

The CATV network of FIG. 1 is roughly comprised of a program provider 101, manufacturing and providing a broadcasting program, a system operator (SO) 102, changing channels of a program received from the program provider 101 and a program manufactured by the SO 102 to provide a broadcasting service to a subscriber 105, a CATV transmission network 103, transmitting a broadcasting signal to the SO 102, and a CATV subscriber distribution network 104, transmitting the broadcasting signal from the SO 102 to the subscriber 105.

The CATV subscriber distribution network 104 includes optical cables and coaxial cables that coexist between a distribution center 107 and the subscriber 105. Hence, the CATV subscriber distribution network 104 is called an HFC network and can provide a CATV service and an Internet service. The SO 102, which is a service provider, includes a broadcasting unit 106 and the distribution center 107. The broadcasting unit 106 transmits received contents to the subscriber 105 or transmits to the subscriber 105 received contents into which corresponding advertisements or subtitles are inserted. The distribution center 107 transmits a broadcasting signal. The CATV subscriber distribution network 104 includes optical network units (ONUs) 108, converting a received optical signal into an electrical signal. An electrical signal, into which broadcasting data is converted by the ONUs 108, is provided to the subscriber 105 through the coaxial cables. The CATV subscriber distribution network 104 may use repeaters and splitters (not sown). The number of repeaters used depends on remoteness of a subscriber, and the number of splitters used depends on the number of subscribers to be provided with services.

A major object of the use of such an HFC CATV network is to provide a CATV broadcasting service. An Internet service, a VOD service, a telephone service, and the like are also provided using a part of a bandwidth of the HFC CATV network. Thus, the use of the HFC CATV network is the most strongly recommended as a technique of providing an integrated communications and broadcasting service that is commonly used at present.

However, since a CATV network is designed based on a broadcasting network, the CATV network lacks a bandwidth for data communications to provide an Internet service. A VOD broadcasting service is not easy because of the insufficient bandwidth for data communications. At present, a cable technology standard for a new HFC network is being established to handle a VOD broadcasting service. However, the standard requires a subscriber and an SO to include new service equipment.

The CATV transmission network 103, between the program provider 101 and the SO 102, uses an asynchronous transfer mode (ATM) transport network or a dedicated line (not shown). When the ATM transport network is used, transmission efficiency is low. When the dedicated line is used, a service price is high.

FIG. 2 illustrates a structure of a satellite broadcasting network which provides a conventional satellite broadcasting.

In contrast with a terrestrial broadcasting achieved by a broadcasting station sending broadcasting electrical waves to a transmission place existing in each region and the transmission place transmitting the broadcasting electrical waves to each home, satellite broadcasting is achieved by transporting programs received from a channel provider 201 (which is called a program provider (PP)) while transmitting electrical waves corresponding to the programs to the ground via a satellite 202, for example, a sky life broadcasting center. At present, a digital satellite broadcasting is being provided in Korea and requires a separate rate and separate equipment (e.g., a satellite antenna and an STB).

However, the satellite broadcasting requires a separate network, such as, a telephone line 204, and an additional cost to provide a VOD service or an Internet service. Thus, satellite broadcasting has several disadvantages when providing an integrated communications and broadcasting service. Also, contents for satellite broadcasting are not compatible with those for CATV broadcasting.

FIG. 3 illustrates a network that covers conventional VOD and Internet broadcasting services. In an Internet network based on a router system, data for VOD broadcasting and Internet broadcasting are transmitted to an Internet user 308 using an IP multicast.

A program provider 301 capsulates MPEG data for broadcasting into an IP packet using a bandwidth pre-allocated by a backbone network 303 and transmits the IP packet through an Internet network or through a dedicated line (e.g., a synchronous optical network (SONET) or a giga Ethernet) to access routers 302, functioning as an SO. A subscriber network through which the access routers 302 transmit data to a subscriber may be a point to point network or a point to multi-point network, but must support an IP multicasting function. When the subscriber network is formed of only Ethernet, the subscriber network must provide n Internet Group Message Protocol (IGMP) Snooping function or a GARP Multicast Registration Protocol (GMRP) function.

Up to now, there is not yet proposed a specific method of economically and efficiently providing a combination of broadcasting services integrated through a single line or a single protocol with communications to home. Hence, an efficient method capable of providing all services including communications and broadcasting through a single line lead into home is demanded.

In the methods of providing an integrated communications and broadcasting service using the HFC network and using the satellite broadcasting network, a communications service is added to a broadcasting service. On the other hand, in the method of providing an integrated communications and broadcasting service using an existing IP-based Internet network, a broadcasting service is additionally achieved in a communications infrastructure. However, these three methods have difficulty in providing all services including communications and broadcasting using a single network and a single platform. In other words, a technique capable of providing a combination of an Internet service, a CATV broadcasting service, a satellite broadcasting service, VOD and Internet broadcasting, and the like through a single network has not yet been invented.

Hence, in the conventional methods, various lines are needed to provide various broadcastings through various situations and an Internet data service, and users must include dedicated devices for the various lines.

### SUMMARY OF THE INVENTION

The present invention provides a system for and a method of providing an integrated communications and broadcasting service, by which various communications services and various broadcasting services can be provided through a single platform using a network obtained by minimally changing an existing network structure.

According to an aspect of the present invention, there is provided a system providing an integrated communications and broadcasting service, the system including a transmitter and a receiver. The transmitter converts a CATV broadcasting signal and a satellite broadcasting signal into a CATV broadcasting optical signal and a satellite broadcasting optical signal having predetermined wavelengths, wavelength-multiplexes the two broadcasting optical signals, and wavelength-multiplexes a wavelength-multiplexed broadcasting signal with an Internet data signal to transmit an integrated communications and broadcasting optical signal via a predetermined optical fiber. The receiver receives the integrated communications and broadcasting optical signal from the transmitter, demultiplexes the received signal according to a wavelength band, converts the CATV broadcasting optical signal, the satellite broadcasting optical signal, and the Internet data signal, into which the received signal is demultiplexed, into RF signals, and transports the RF signals to appropriate terminals.

According to another aspect of the present invention, there is provided a method of providing an integrated communications and broadcasting service. In this method, a CATV broadcasting signal and a satellite broadcasting signal are converted into a CATV broadcasting optical signal and a satellite broadcasting optical signal having predetermined wavelengths, and the two optical signals are wavelength-multiplexed. A signal obtained by the wavelength-multiplexing of the two broadcasting optical signals and an Internet data signal are wavelength-multiplexed. An integrated communications and broadcasting optical signal obtained by the wavelength-multiplexing of the wavelength-multiplexed broadcasting signal and the Internet data signal is transmitted. The integrated communications and broadcasting optical signal is received and demultiplexed according to a wavelength band so that the integrated optical signal is separated into the CATV broadcasting optical signal, the satellite broadcasting optical signal, and the Internet data signal. The CATV broadcasting optical signal, the satellite broadcasting optical signal, and the Internet data signal are converted into RF signals, which are transmitted to appropriate terminals.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a CATV network using a conventional hybrid fiber coaxial (HFC) network;

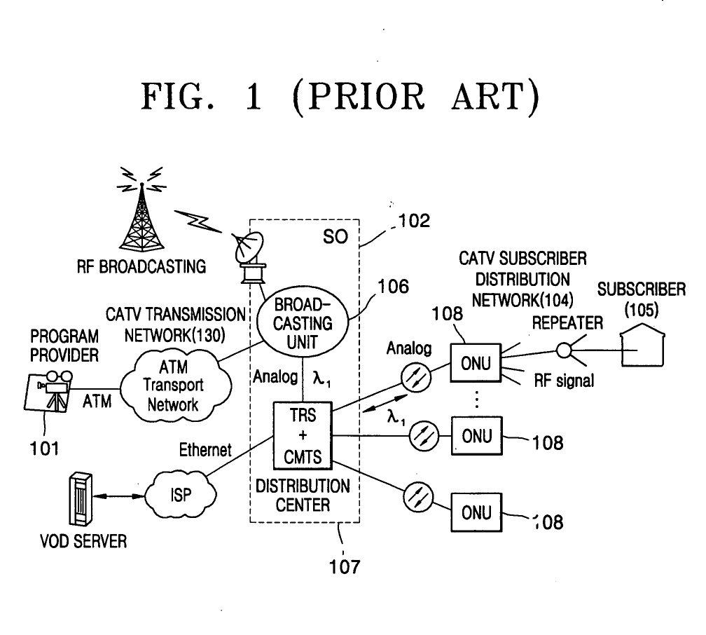

FIG. 2 illustrates a structure of a satellite broadcasting network which provides a conventional satellite broadcasting;

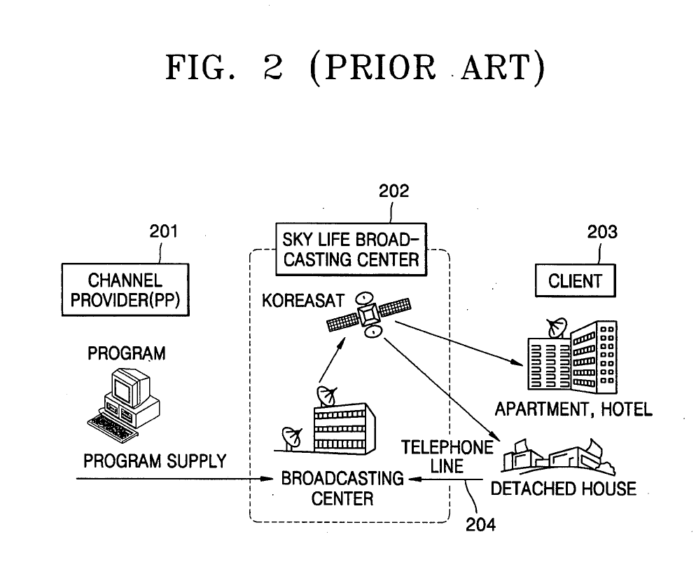

FIG. 3 illustrates a structure of a network that covers conventional VOD and Internet broadcasting services;

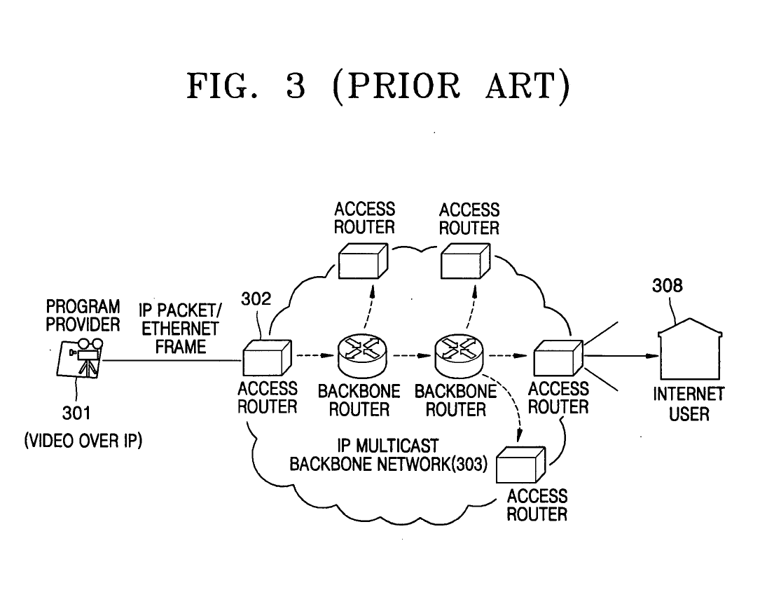

FIG. 4 illustrates a network that uses a system for providing an integrated communications and broadcasting service according to an embodiment of the present invention;

FIG. 5 illustrates a structure of a system for providing an integrated communications and broadcasting service, according to an embodiment of the present invention;

FIG. 6 illustrates detailed structures of a broadcasting transmission portion and a data transmission portion of a transmitter, according to an embodiment of the present invention;

FIG. 7 illustrates a detailed structure of a receiver according to an embodiment of the present invention; and

FIG. 8 is a flowchart of a method of providing an integrated communications and broadcasting service, according to an embodiment of the present invention.

### DETAILED DESCRIPTION OF THE INVENTION

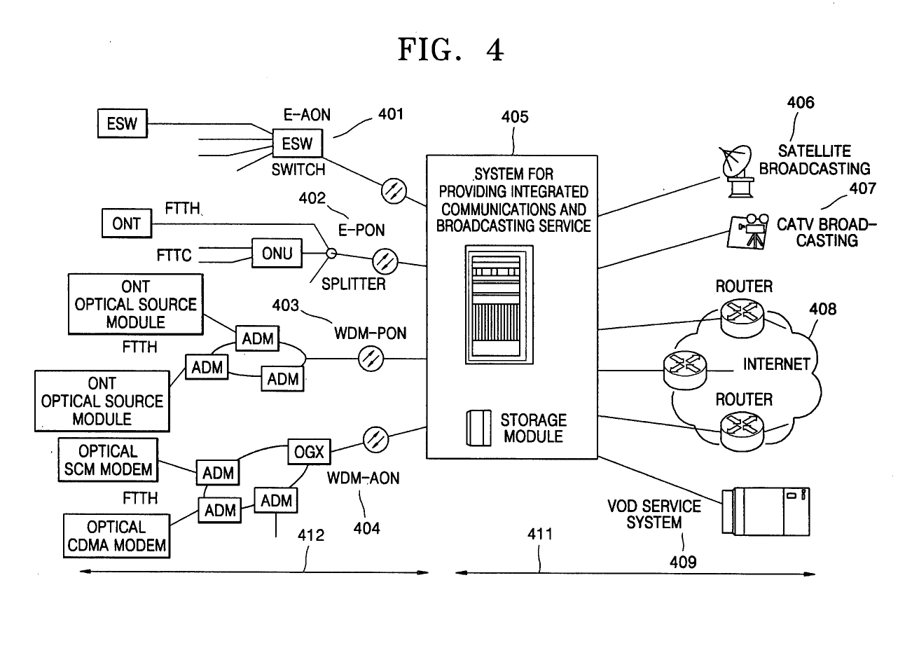

FIG. 4 illustrates an example of a network that uses a system 405 for providing an integrated communications and broadcasting service according to the present invention. This network includes the system 405, a service transport network 411, for providing broadcasting or communications programs, and an optical subscriber network 412.

The service transport network 411 includes a satellite broadcasting 406, a CATV broadcasting 407. a VOD service system 409, and an Internet network 408. The access system 405 matches the various service networks included in the service transport network 411 with one another and transmits a service signal obtained by the matching to the optical subscriber network 412, which contains actual subscribers.

The optical subscriber network 412 includes an E-active optical network (AON) 401, an E-passive optical network (PON) 402, a wavelength division multiplexing-PON (WDM-PON) 403, a WDM-AON 404, and the like according to a network structure and a method of forming a network structure. The optical subscriber network 412 may further include other types of networks that are comprised of optical cables.

The access system 405 having such a structure receives all kinds of services, such as, a satellite broadcasting, a CATV broadcasting, a VOD broadcasting, an Internet service, and the like and distributes these services to subscribers via optical cables.

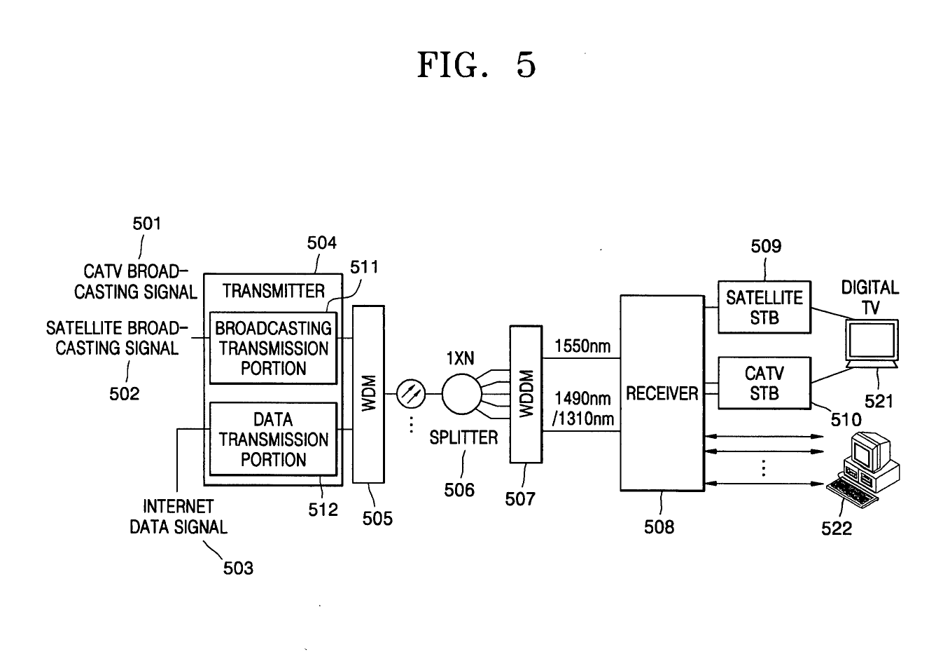

FIG. 5 illustrates a structure of a system for providing an integrated communications and broadcasting service, according to an embodiment of the present invention. FIG. 5 illustrates a structure of a system for providing an integrated communications and broadcasting service through an E-PON in the optical subscriber network 412 of FIG. 4.

The access system for providing an integrated communications and broadcasting service includes a transmitter 504 and a receiver 508. The transmitter 504 transforms a CATV broadcasting signal 501 and a satellite broadcasting signal 502 into optical signals having predetermined wavelengths, multiplexes the two optical signals 501 and 502, and multiplexes a multiplexed optical signal and an Internet data signal 503 to transmit an integrated communications and broadcasting optical signal via an optical fiber. The receiver 508 receives the integrated communications and broadcasting optical signal from the transmitter 504, demultiplexes the same according to a wavelength band, transforms the demultiplexed CATV broadcasting signal, the demultiplexed satellite broadcasting signal, and the demultiplexed Internet data signal, into which the integrated communications and broadcasting optical signal is demultiplexed, into RF signals and transmits the RF signals to corresponding terminals.

Preferably, the transmitter 504 includes a broadcasting transmission portion 511 and a data transmission portion 512. The broadcasting transmission portion 511 transforms the CATV broadcasting signal 501 and the satellite broadcasting signal 502 into optical signals having different wavelengths and multiplexes the optical signals to output a single optical signal. The data transmission portion 512 processes the Internet data signal 503 using a predetermined method for Internet services including switching and transforms the Internet data signal 503 into an optical signal having a predetermined wavelength.

Preferably, the satellite broadcasting signal 502 has a frequency band of 950 to 2150 MHz, and the CATV broadcasting signal 501 has a frequency band of 50 to 870 MHz.

The transmitter 504 may further include a wavelength division multiplexer (WDM) 505, which multiplexes an output signal of the broadcasting transmission portion 511 and an output signal of the data transmission portion 512. An optical signal produced by the WDM 505 is applied to a splitter 506 for increasing the number of subscribers. Hence, as many optical signals as an increased number of subscribers are output by the splitter 506 and then transmitted to the receiver 508.

A wavelength division demultiplexer 507 demultiplexes the optical signals received from the splitter 506 according to a wavelength band and transmits demultiplexed optical signals to the receiver 508.

The transmitter 504 matches the CATV broadcasting signal 501, the satellite broadcasting signal 502, and the Internet data signal 503 with one another and distributes a matching result to subscribers.

The broadcasting transmission portion 511 matches and multiplexes the CATV broadcasting signal 501 and the satellite broadcasting signal 502, transforms a multiplexed broadcasting signal into an optical signal, and transmits the optical signal. Processing of the broadcasting signals 501 and 502 corresponds to a broadcasting function. Consequently, the broadcasting transmission portion 511 performs a one-way transmission.

The data transmission portion 512 transmits and receives IP-based data, that is, serves as an interface for not only data transmitted through an Internet network but also a VOD broadcasting service.

The data transmission portion 512 performs a communications function, that is, a bi-directional optical transmission. In an E-PON illustrated in FIG. 5, bi-directional communications are performed using a single optical fiber, so data communications are performed using optical signals having two different wavelengths of 1490 nm and 1310 nm.

In the E-PON, Internet data communications are performed using 1490 nm as a wavelength of a downward optical signal of the Internet data signal 503 (i.e., an output signal of the transmitter 504) and 1310 nm as a wavelength of an upward optical signal of the Internet data signal 503 (i.e., an input signal of the transmitter 504).

A wavelength (e.g., 1550 nm) of an optical signal output by the broadcasting transmission portion 511 must be different from a wavelength (e.g., 1490 nm/1310 nm) of an optical signal input to/output by the data transmission portion 512. The optical signals output by the broadcasting transmission portion 511 and the data transmission portion 512 are input to the WDM 505 (hereinafter, referred to as a WDM coupler for transmission) and multiplexed thereby. A multiplexed optical signal is output as the downward optical signal to a single optical fiber. The upward optical signal is input to the data transmission portion 512. As a result, three optical signals having different wavelengths exist on the single optical fiber to provide an integrated communications and broadcasting service.

Hence, data received through a communications network and multiplexed multi-channel broadcasting signals are integrated and provided to the single optical fiber.

The splitter 506 is a passive device for extending the number of subscribers over an E-PON. For example, the number of subscribers can be extended up to 64. Although the E-PON is used as an example of a subscriber network in FIG. 5, a network through which transmission and reception are separately performed, such as, a metro-Ethernet network, may be used. Also, an optical fiber used is not necessarily the single optical fiber.

The WDDM 507 (hereinafter, referred to as a WDM coupler for reception) is a passive device located on a subscriber side and divides a wavelength of the optical signal into which the optical signals output by the broadcasting transmission portion 511 and the data transmission portion 512 are multiplexed by the WDM coupler for transmission 505.

The receiver 508 transforms an optical signal for broadcasting and an optical signal for data communications, into which the multiplexed optical signal is demultiplexed by the WDM coupler for reception 507, into electrical signals corresponding to services and transmits the electrical signals to service platforms, such as, a satellite STB 509, a CATV STB 510, and a PC 522 within a subscriber's house. As described above, several service platforms are used to cover several services in FIG. 5, but a single platform may be used for the several services.

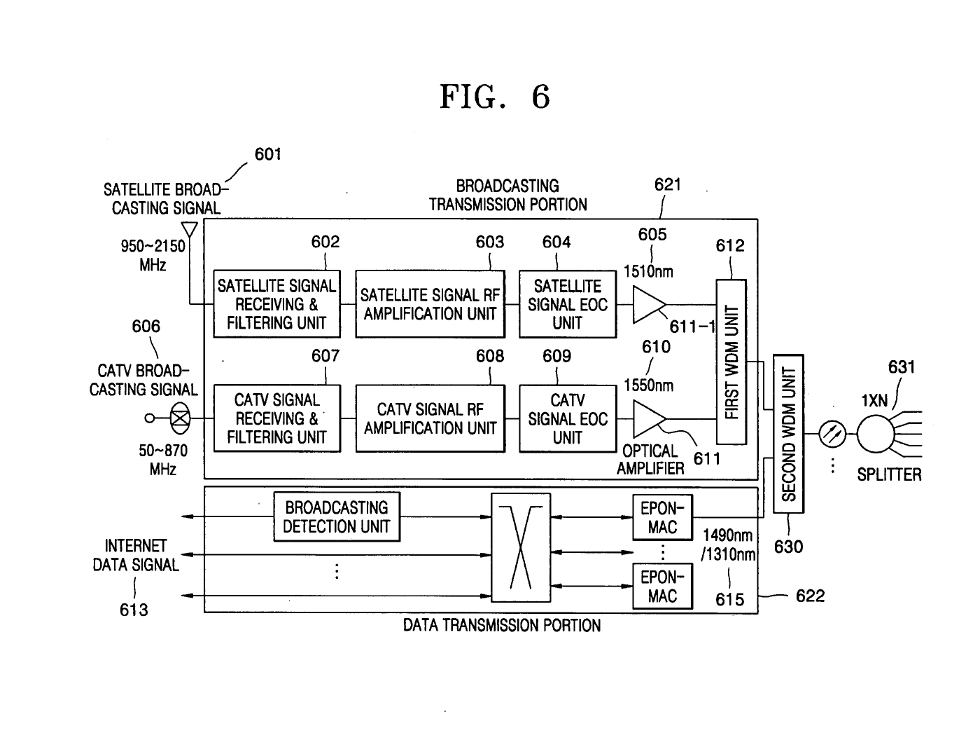

FIG. 6 illustrates detailed structures of a broadcasting transmission portion 621 and a data transmission portion 622 of a transmitter, according to an embodiment of the present invention.

The broadcasting transmission portion 621 includes a satellite signal receiving & filtering unit 602, receiving and filtering a satellite broadcasting signal 601, a satellite signal RF amplification unit 603, amplifying a satellite broadcasting signal filtered by the satellite signal receiving & filtering unit 602 according to a frequency band of the satellite broadcasting signal, a satellite signal electric-to-optic conversion (EOC) unit 604, converting an electrical signal output by the satellite signal RF amplification unit 603 into an optical signal having a predetermined wavelength, a CATV signal receiving & filtering unit 607, receiving and filtering a CATV broadcasting signal 606, a CATV signal RF amplification unit 608, amplifying a CATV broadcasting signal filtered by the CATV signal receiving & filtering unit 607 according to a frequency band of the CATV broadcasting signal, a CATV signal EOC unit 609, converting an electrical signal output by the CATV signal RF amplification unit 608 into an optical signal having a predetermined wavelength, and a first WDM unit 612, wavelength-multiplexing the optical signals output by the satellite signal EOC unit 604 and the CATV signal EOC unit 609.

The broadcasting transmission portion 621 preferably further includes an optical amplifier 611, amplifying an output of an optical signal produced by the CATV signal EOC unit 609, and an optical amplifier 611-1, amplifying an output of an optical signal produced by the satellite signal EOC unit 604. In this case, optical signals amplified by the optical amplifiers 611 and 611-1 are input to the first WDM unit 612 and wavelength-multiplexed thereby.

The transmitter may further include a second WDM unit 630 for wavelength-multiplexing an output signal of the first WDM unit 612 and an output signal of the data transmission portion 622.

According to current broadcasting characteristics, a satellite broadcasting and a CATV broadcasting use different frequency bands. The CATV broadcasting uses a frequency band of 50 to 870 MHz, and the satellite broadcasting passes through a low noise block (LNB) module and is then transmitted using a frequency band of 950 to 2150 MHz.

Two multi-channel broadcastings, which are satellite and CATV broadcastings having different frequency bands, are filtered by the satellite signal receiving & filtering unit 602 and the CATV signal receiving & filtering unit 607, respectively, and then amplified by the satellite signal RF amplification unit 603 and the CATV signal RF amplification unit 608, respectively.

Electrical signals corresponding to the satellite and CATV broadcastings amplified by the satellite signal RF amplification unit 603 and the CATV signal RF amplification unit 608 are converted into optical signals having different wavelengths by the satellite signal EOC unit 604 and the CATV signal EOC unit 609, respectively. Although wavelengths of the optical signals can be determined according to system characteristics, a 1510 nm wavelength 605 and a 1550 nm wavelength 610 are used for the satellite broadcasting and the CATV broadcasting, respectively, in the embodiment of FIG. 6. The two optical signals having different wavelengths are multiplexed by the first WDM unit 612, which is a WDM for broadcasting.

The data transmission portion 622 transmits and receives IP-based data and performs a function such as L2/L3 switching for a conventional Internet service. Like a commonly used E-PON system providing an IP/Ethernet-based service, the illustrated E-PON has a structure in which an EPON media access control (MAC) mastering is performed. Hence, the data transmission portion 622 processes an Internet data signal 613 using the same method as a method of processing data in a conventional Internet network. Alternatively, the data transmission portion 622 may use a conventional way in which an optical signal is used, to process Internet data.

As described above with reference to FIG. 5, in the E-PON of the data transmission portion 622 of FIG. 6, Internet data communications are performed using an optical signal having a 1490 nm/1310 nm wavelength 615 in which 1490 nm and 1310 nm are used as a wavelength of a downward optical signals of the Internet data signal 613 (i.e., an output signal of the transmitter) and a wavelength of an upward optical signal of the Internet data signal 613 (i.e., an input signal of the transmitter), respectively.

The optical signals output by the first WDM 612 of the broadcasting transmission portion 621 and the data transmission portion 622 are input to the second WDM 630 (which is also called as a WDM coupler for transmission) and multiplexed thereby. A multiplexed optical signal obtained by the second WDM 630 is output as the downward optical signal to a single optical fiber. The upward optical signal is input to the data transmission portion 622. As a result, three optical signals having different wavelengths exist on the single optical fiber to provide an integrated communications and broadcasting service.

Preferably, the multiplexed optical signal obtained by the second WDM 630 and transmitted via the optical fiber has a wavelength of 1200 to 1600 nm.

This optical signal is input to the receiver 508, which is located on a subscriber side, via a splitter 631, having one input port and N output ports.

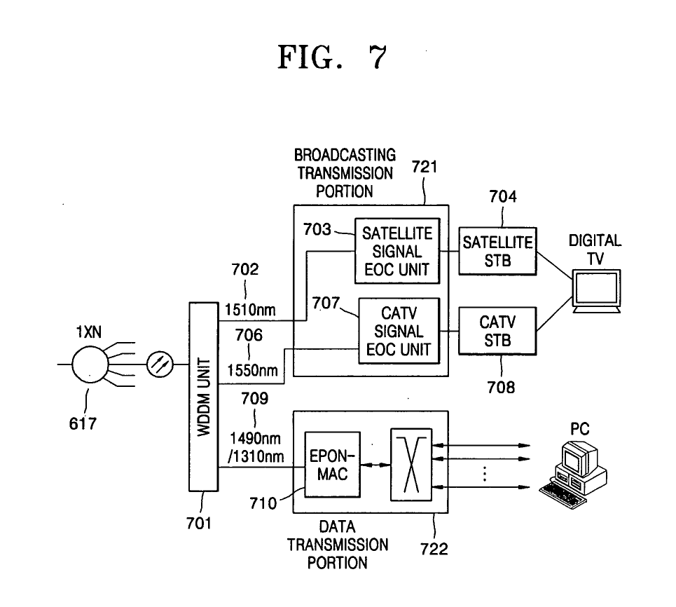

FIG. 7 illustrates a detailed structure of a receiver according to an embodiment of the present invention. The receiver includes a WDDM unit 701, which demultiplexes a multiplexed optical signal split by a splitter 617 according to a wavelength band.

The receiver includes a broadcasting receiving portion 721 and a data receiving portion 722. The broadcasting receiving portion 721 transmits a CATV broadcasting signal and a satellite broadcasting signal, into which a multiplexed optical signal is demultiplexed according to a wavelength band, to corresponding terminals. The data receiving portion 722 processes an Internet data signal, into which the multiplexed optical signal is demultiplexed according to a wavelength band, using a predetermined method for Internet services including switching and transmits the processed Internet data signal to a corresponding terminal.

The broadcasting receiving portion 721 includes a satellite signal optic-to-electric conversion (OEC) unit 703, for converting a satellite broadcasting optical signal 702, into which the multiplexed optical signal is demultiplexed by the WDDM unit 701, into an electrical RF signal, and a CATV signal OEC unit 707, for converting a CATV broadcasting optical signal 706, into which the multiplexed optical signal is demultiplexed by the WDDM unit 701, into an electrical RF signal.

The WDDM unit 701, which is a WDM coupler for reception, demultiplexes the multiplexed optical signal into the satellite broadcasting optical signal 702, the CATV broadcasting optical signal 706, and a data optical signal 709.

The receiver receives the satellite broadcasting optical signal 702, the CATV broadcasting optical signal 706, and the data optical signal 709 and converts the same into electrical signals.

The satellite signal OEC unit 703 converts the satellite broadcasting optical signal 702, having a 1510 nm wavelength, into an RF signal of 950 to 250 MHz and outputs the RF signal to a satellite STB 704, which is a service platform. The CATV signal OEC unit 707 converts the CATV broadcasting optical signal 706, having a 15550 nm wavelength, into an electrical RF signal of 50 to 870 MHz and outputs the RF signal to a CATV STB 708. In other words, a satellite broadcasting optical signal and a CATV broadcasting optical signal are distinguished from each other according to a wavelength. The original satellite broadcasting signal and the original CATV broadcasting signal are distinguished from each other according to a frequency band.

As described above, the data receiving portion 722 transmits or receives the data optical signal 709, which has a wavelength of 1490 nm or 1310 nm depending on whether the signal 709 is an upward signal or a downward signal. The data receiving portion 722 is a functional block which receives and processes IP-based data, so performs EPON MAC slayering 710 and Ethernet switching over the illustrated E-PON as in a functional block of a commonly used E-PON system for providing an IP/Ethernet-based service. Hence, the data receiving portion 722 processes data in the same way as the way of processing data in a conventional Internet network. The data receiving portion 722 may use a conventional method of processing an optical signal without change.

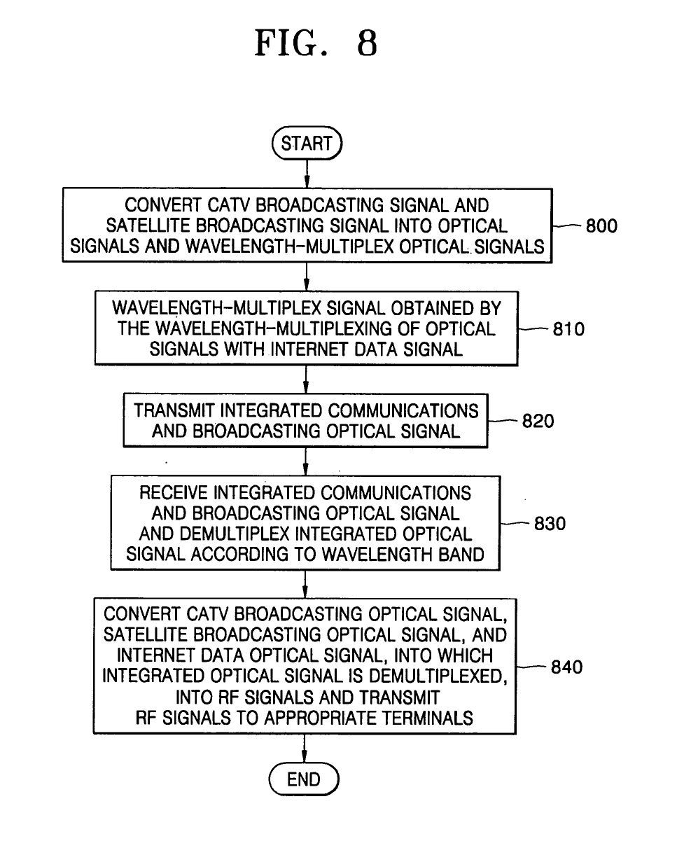

FIG. 8 is a flowchart of a method of providing a combined service of communications and broadcasting, according to an embodiment of the present invention. This method includes operations 800, 810, and 820, which are performed in a transmitter, and operations 830 and 840, which are performed in a receiver. In operation 800, the transmitter converts a CATV broadcasting signal and a satellite broadcasting signal into optical signals having predetermined wavelengths and wavelength-multiplexes the optical signals. In operation 810, the transmitter wavelength-multiplexes a signal obtained by the wavelength-multiplexing of the two optical signals with an Internet data signal. In operation 820, the transmitter transmits an integrated communications and broadcasting optical signal obtained by the wavelength-multiplexing in operation 810 to the receiver.

In operation 830, the receiver receives the integrated communications and broadcasting optical signal and demultiplexes the optical signal according to a wavelength band so that the integrated optical signal is separated into a CATV broadcasting optical signal, a satellite broadcasting optical signal, and an Internet data optical signal. In operation 840, the receiver converts the CATV broadcasting optical signal, the satellite broadcasting optical signal, and the Internet data optical signal into RF signals and transmits the RF signals to appropriate terminals.

Since these operations are the same as described above with reference to FIGS. 5 through 7, detailed descriptions thereof will be omitted herein.

A system for providing an integrated communications and broadcasting service according to the present invention includes a transmitter and a receiver. The transmitter converts a CATV broadcasting signal and a satellite broadcasting signal into optical signals having predetermined wavelengths, wavelength-multiplexes the two broadcasting signals, and wavelength-multiplexes a wavelength-multiplexed broadcasting signal with an Internet data signal to transmit an integrated communications and broadcasting optical signal via a predetermined optical fiber to the receiver. The receiver receives the integrated communications and broadcasting optical signal, demultiplexes the received signal according to a wavelength band, converts the CATV broadcasting optical signal, the satellite broadcasting optical signal, and the Internet data signal, into which the received signal is demultiplexed, into RF signals, and transports the RF signals to appropriate terminals. This system can provide an integrated broadcasting service including various types of broadcasting services through a single communications network. Hence, service providers can use an efficient network, and subscribers can receive several services through a single platform. In other words, a broadcasting service and an Internet service, such as, a CATV broadcasting, a satellite broadcasting, a multi-channel Internet broadcasting, a VOD broadcasting, and the like, can be simultaneously provided through a single wire line.

This system according to the present invention and a method of providing an integrated communications and broadcasting service using this system have the following advantages, compared with a conventional Internet network or a convention broadcasting network. First, in contrast with a conventional system in which a CATV broadcasting network, a satellite broadcasting network, and a subscriber network for Internet services separately exist to provide corresponding services to subscribers, the CATV broadcasting network, the satellite broadcasting network, and the subscriber network for Internet services are integrated to provide a multiplexed optical signal. Thus, a combination of communications and broadcasting can be simply achieved, and all services can be provided to subscribers through a single optical subscriber network.

Second, a satellite broadcasting signal and a CATV broadcasting signal can be easily multiplexed because they use different frequency bands, and a multiplexing technique required by digital broadcasting can be easily applied to the multiplexing of the broadcasting signals. Thus, the method according to the present invention can be more simply implemented than a method of providing an integrated communications and broadcasting service using conversion of an RF signal into an IP frame.

Third, in a conventional art, equipments corresponding to different services, such as, a CATV STB, a satellite antenna & a satellite STB, Internet equipment, and the like, must be separately installed. However, in the present invention, all broadcasting services and communications services can be provided through a single line, so separate equipments that a subscriber needed to receive all services can be integrated. Consequently, the number of systems within a house can be drastically reduced, thereby achieving a cost-efficient service supply.

Fourth, a satellite broadcasting signal and a CATV broadcasting signal can be easily multiplexed because they use different frequency bands, and a multiplexing technique required by digital broadcasting can be easily applied to the multiplexing of the broadcasting signals. Thus, the method according to the present invention can be more simply implemented than a method of providing an integrated communications and broadcasting service using in-band broadcasting.

Fifth, a CATV broadcasting signal and a satellite broadcasting signal are multiplexed to transmit an optical signal having a single wavelength, so the number of WDM couplers and the number of wavelengths divided by the WDM coupler for reception can be reduced. The number of extra optical amplifiers required to transmit CATV broadcasting and satellite broadcasting can also be reduced. Thus, costs of forming an integrated communications and broadcasting network are reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

Also, it can be easily recognized by one of ordinary skill in the art that operations of the method according to the present invention can be implemented in various software or hardware ways by using a general programming technique.

1. A system providing an integrated communications and broadcasting service, the system comprising:
a transmitter converting a CATV broadcasting signal and a satellite broadcasting signal into a CATV broadcasting optical signal and a satellite broadcasting optical signal having predetermined wavelengths, wavelength-multiplexing the two broadcasting optical signals, and wavelength-multiplexing a wavelength-multiplexed broadcasting signal with an Internet data signal to transmit an integrated communications and broadcasting optical signal via a predetermined optical fiber; and
a receiver receiving the integrated communications and broadcasting optical signal from the transmitter, demultiplexing the received signal according to a wavelength band, converting the CATV broadcasting optical signal, the satellite broadcasting optical signal, and the Internet data signal, into which the received signal is demultiplexed, into RF signals, and transporting the RF signals to appropriate terminals.

2. The system of claim 1, wherein;
the transmitter comprises a broadcasting transmission portion converting the CATV broadcasting signal and the satellite broadcasting signal into the CATV broadcasting optical signal and the satellite broadcasting optical signal and wavelength-multiplexing the two optical signals to output a single optical signal; and
the broadcasting transmission portion comprises:
a satellite signal receiving & filtering unit receiving and filtering the satellite broadcasting signal;
a satellite signal RF amplification unit amplifying a satellite broadcasting signal filtered by the satellite signal receiving & filtering unit according to a frequency band of the satellite broadcasting signal;
a satellite signal electric-to-optic conversion unit converting a satellite broadcasting signal, which is an electrical signal, output by the satellite signal RF amplification unit into an optical signal having a predetermined wavelength;
a CATV signal receiving & filtering unit receiving and filtering a CATV broadcasting signal;
a CATV signal RF amplification unit amplifying a CATV broadcasting signal filtered by the CATV signal receiving & filtering unit according to a frequency band of the CATV broadcasting signal;
a CATV signal electric-to-optic conversion unit converting an electrical signal output by the CATV signal RF amplification unit into an optical signal having a predetermined wavelength; and
a first wavelength division multiplexing unit wavelength-multiplexing the optical signals output by the satellite signal electric-to-optic conversion unit and the CATV signal electric-to-optic conversion unit.

3. The system of claim 1 or 2, wherein the satellite broadcasting signal has a frequency band of 950 MHz to 2150 MHz, and the CATV broadcasting signal has a frequency band of 50 MHz to 870 MHz.

4. The system of claim 2, wherein the broadcasting transmission portion further comprises:
an optical amplifier amplifying an output of the optical signal obtained by the CATV signal electric-to-optical conversion unit; and
an optical amplifier amplifying an output of the optical signal obtained by the satellite signal electric-to-optical conversion unit.

5. The system of claim 1, wherein the transmitter comprises a data transmission portion processing the Internet data signal using a predetermined method for Internet services including switching and converting the Internet data signal into an optical signal having a predetermined wavelength.

6. The system of claim 2, wherein the transmitter further comprises a second wavelength division multiplexing unit wavelength-multiplexing an output signal of the first wavelength division multiplexing unit and an output signal of the data transmission portion.

7. The system of claim 6, wherein an optical signal produced by the second wavelength division multiplexing unit and transmitted via an optical fiber has a wavelength of 1200 to 1600 nm.

8. The system of claim 1, wherein the integrated communications and broadcasting optical signal transmitted by the transmitter is received by a splitter extending a number of subscribers, and as many optical signals as the extended number of subscribers are output by the splitter and transmitted to the receiver.

9. The system of claim 1, wherein the receiver comprises a wavelength division demultiplexing unit demultiplexing the received wavelength-multiplexed optical signals according to a wavelength band.

10. The system of claim 1, wherein:
the receiver comprises a broadcasting receiving portion transmitting a CATV broadcasting signal and a satellite broadcasting signal, into which the integrated communications and broadcasting optical signal received from the transmitter is demultiplexed according to a wavelength band, to corresponding terminals; and
the broadcasting receiving portion comprises:
a satellite signal optic-to-electric conversion unit converting a satellite broadcasting optical signal, into which the integrated communications and broadcasting optical signal is demultiplexed by the wavelength division demultiplexing unit, into an electrical RF signal; and
a CATV signal optic-to-electric conversion unit converting a CATV broadcasting optical signal, into which the integrated communications and broadcasting optical signal is demultiplexed by the wavelength division demultiplexing unit, into an electrical RF signal.

11. The system of claim 10, wherein the receiver comprises a data receiving portion processing an Internet data signal, into which the integrated communications and broadcasting optical signal is demultiplexed according to a wavelength band, using a predetermined method for Internet services including switching and transmitting the processed Internet data signal to a corresponding terminal.

12. A method of providing an integrated communications and broadcasting service, the method comprising:
converting a CATV broadcasting signal and a satellite broadcasting signal into a CATV broadcasting optical signal and a satellite broadcasting optical signal having predetermined wavelengths and wavelength-multiplexing the two optical signals;
wavelength-multiplexing a signal obtained by the wavelength-multiplexing of the two broadcasting optical signals and an Internet data signal;
transmitting an integrated communications and broadcasting optical signal obtained by the wavelength-multiplexing of the wavelength-multiplexed broadcasting signal and the Internet data signal;
receiving the integrated communications and broadcasting optical signal and demultiplexing the optical signal according to a wavelength band so that the integrated optical signal is separated into the CATV broadcasting optical signal, the satellite broadcasting optical signal, and the Internet data signal; and
converting the CATV broadcasting optical signal, the satellite broadcasting optical signal, and the Internet data signal into RF signals and transmits the RF signals to appropriate terminals.

13. The method of claim 12, wherein the converting of the CATV broadcasting signal and the satellite broadcasting signal into the optical signals and the wavelength-multiplexing of the two optical signals comprises:
receiving and filtering the satellite broadcasting signal and the CATV broadcasting signal;
amplifying the satellite broadcasting signal and the CATV broadcasting signal according to a frequency band;
converting an amplified satellite broadcasting signal and an amplified CATV broadcasting signal, which are RF signals, into the satellite broadcasting optical signal and the CATV broadcasting optical signal having predetermined wavelengths; and
wavelength-multiplexing the satellite broadcasting optical signal and the CATV broadcasting optical signal.

14. The method of claim 13, after the converting of the two broadcasting RF signals into the optical signals, further comprising amplifying outputs of the satellite broadcasting optical signal and the CATV broadcasting optical signal.

15. The method of claim 12, before the receiving and wavelegth-demultiplexing of the integrated communications and broadcasting optical signal, further comprising splitting the integrated communications and broadcasting optical signal into as many optical signals as an increased number of subscribers to provide a service to the increased number of subscribers.
